(19) United States
(12) Patent Application Publication
(10) Pub. No.: US 2020/0242937 A1
(43) Pub. Date: Jul. 30, 2020

(54) APPARATUS AND METHOD FOR MONITORING SURROUNDINGS OF VEHICLE

(71) Applicant: DENSO CORPORATION, Kariya-city (JP)

(72) Inventors: Shogo OMIYA, Kariya-city (JP); Hirohiko YANAGAWA, Kariya-city (JP)

(21) Appl. No.: 16/749,097

(22) Filed: Jan. 22, 2020

(30) Foreign Application Priority Data
Jan. 25, 2019 (JP) 2019-011444

(51) Int. Cl. G08G 1/16; G08G 1/056; G08G 1/04

(52) U.S. Cl. CPC G08G 1/16; G08G 1/04; G08G 1/056

(57) ABSTRACT

In an apparatus for monitoring surroundings of a vehicle, a road surface recognizer recognizes from an image of surroundings of the vehicle captured by a camera, a road surface on which the vehicle can travel. A travel trajectory estimator estimates a travel trajectory from a current location of the vehicle based on a steering state of the vehicle. A travelable degree calculator calculates, based on the travel trajectory estimated by the travel trajectory estimator and a result of recognition of the road surface by the road surface recognizer, a travelable degree that is a degree to which the vehicle can travel on the road surface. A notifier provides a notification of the travelable degree calculated by the travelable degree calculator.

### CROSS-REFERENCE TO RELATED APPLICATION

This application is based on and claims the benefit of priority from earlier Japanese Patent Application No. 2019-11444 filed on Jan. 25, 2019, the description of which is incorporated herein by reference.

### BACKGROUND

### Technical Field

This disclosure relates to an apparatus and a method for monitoring surroundings of a vehicle, configured to estimate a travel trajectory from a steering state of the vehicle and determine whether or not the vehicle can travel the estimated travel trajectory.

### Related Art

A known apparatus for monitoring surroundings of a vehicle is configured to estimate a travel trajectory of the vehicle from a steering angle of the vehicle and set an obstacle detection area based on the estimated travel trajectory. In the following, such an apparatus is also referred to as a surroundings monitoring apparatus for a vehicle.

The above surroundings monitoring apparatus is configured to search within the detection area using an ultrasonic sensor, and in response to detecting an obstacle within the detection area, determine that the vehicle can not travel the estimated travel trajectory with the current steering angle and provides a notification indicating a steering angle that allows the vehicle to pass through or around the detected obstacle.

### BRIEF DESCRIPTION OF THE DRAWINGS

In the accompanying drawings:

FIG. 1A is a block diagram of a surroundings monitoring apparatus;

FIG. 1B is a functional block diagram of an image processor of an ECU;

FIG. 2 is a flowchart of an input process performed by the ECU;

FIG. 3A is a flowchart of initial portions of a monitoring process performed by the ECU;

FIG. 3B is a flowchart of later portions of the monitoring process performed by the ECU;

FIG. 4 is an example captured image from a camera and a result of road surface recognition from the captured image;

FIG. 5 is an illustration of a calculation procedure of a travelable degree based on a travel trajectory;

FIG. 6 is an illustration of a calculation procedure of a travel margin based on a travel trajectory;

FIG. 7 is an example of top-view and travel direction images that are displayed when a vehicle pulls away from a parking lot;

FIG. 8 is an example travel direction image with a lower travelable degree than in the example of FIG. 7;

FIG. 9 is an example travel direction image with an even lower travelable degree than in the example of FIG. 7; and

FIG. 10 is an example of travel direction and top-view images that are displayed when a vehicle is parked.

### DESCRIPTION OF SPECIFIC EMBODIMENTS

The surroundings monitoring apparatus, as disclosed in JP-A-2005-56336, determines, based on a result of detection of obstacles within the detection area set depending on the estimated travel trajectory, whether or not the vehicle can travel the estimated travel trajectory. Thus, even if a mobile object located outside the detection area is moving toward the vehicle, it is likely to be determined that the vehicle can travel the estimated travel trajectory until the mobile object entering the detection area.

When a mobile object enters the detection area and is detected by the ultrasonic sensor, it will be determined that the vehicle can not travel the estimated travel trajectory and an alert will be provided. However, a detection distance for the ultrasonic sensor to detect obstacles is extremely short, e.g., of the order of two meters.

Thus, even if the surroundings monitoring apparatus has successfully detected a mobile object that has moved into the detection area, and has provided an alert in response thereto, a driver of the vehicle may not be able to operate the vehicle to avoid collision with the mobile object.

In view of the above, it is desired to have an apparatus for monitoring surroundings of a vehicle, configured to estimate a travel trajectory from a steering state of the vehicle and determine whether or not the vehicle can travel the estimated travel trajectory, with higher accuracy, thereby enabling safer driving of the vehicle.

One aspect of this disclosure provides an apparatus for monitoring surroundings of a vehicle, including a road surface recognizer, a travel trajectory estimator, a travelable degree calculator, and a notifier.

The road surface recognizer is configured to recognize from an image of surroundings of the vehicle captured by the camera, a road surface on which the vehicle can travel. The travel trajectory estimator is configured to estimate a travel trajectory from a current location of the vehicle based on a steering state of the vehicle.

The travelable degree calculator is configured to, based on the travel trajectory estimated by the travel trajectory estimator and a result of recognition of the road surface by the road surface recognizer, calculate a travelable degree that is a degree to which the vehicle can travel on the road surface. The notifier is configured to provide a notification of the travelable degree calculated by the travelable degree calculator.

With this configuration, if the travel trajectory of the vehicle includes an area other than the road surface in the captured image from the camera, the vehicle will pass through such an area. Therefore, the travelable degree calculated by the travelable degree calculator is low. The notifier will provide a notification that the travelable degree is low.

The area other than the road surface recognized by the road surface recognizer in the captured image received from the camera may be an area occupied by a fixed object such as a road sign, a construction or the like, or a mobile object such as a pedestrian, a vehicle or the like. An imageable distance of the camera is determined by a focal length of a camera lens or the like, but is normally equal to or greater than ten meters, which is normally greater than an obstacle sensing distance of an ultrasonic sensor.

Therefore, in cases where there is an area at least partially overlapping the travel trajectory, other than the road surface recognized by the road surface recognizer, in the captured image received from the camera and thus there is likely to be an obstacle, such as a mobile object or the like, within the travel trajectory, the above configuration enables detecting the presence of the obstacle at a location further away from the obstacle and notifying that the travelable degree is low.

This configuration allows a driver of the vehicle to recognize that the travelable degree is low and thus take a steering action for collision avoidance in good time. The surroundings monitoring apparatus configured as above can enhance driving safety during traveling of the vehicle, as compared with conventional devices.

The notifier is not necessarily configured to notify a driver of the vehicle of the travelable degree. Alternatively, for example, in cases where the vehicle is an autonomous vehicle or self-driving vehicle with a cruise controller enabling autonomous driving of the vehicle, the notifier may be configured to notify the cruise controller of the travelable degree.

Hereinafter, exemplary embodiments of the present disclosure will be described in detail with reference to the accompanying drawings, in which like reference numerals refer to like or similar elements and duplicated description thereof will be omitted.

### Example Embodiment

Overall Configuration

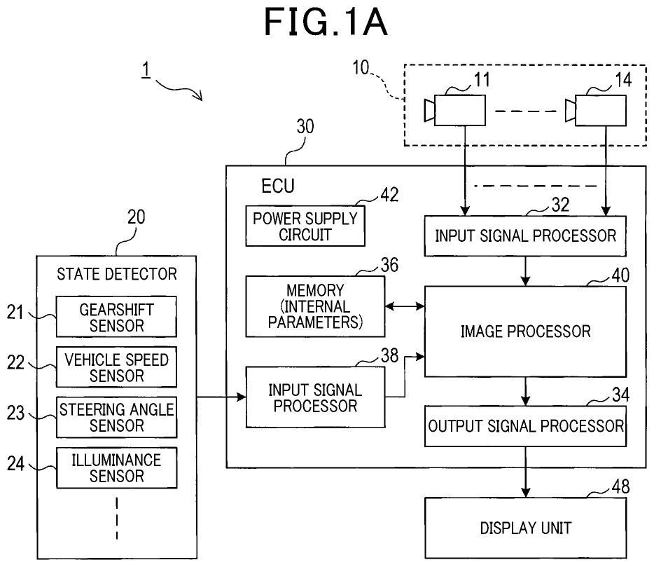

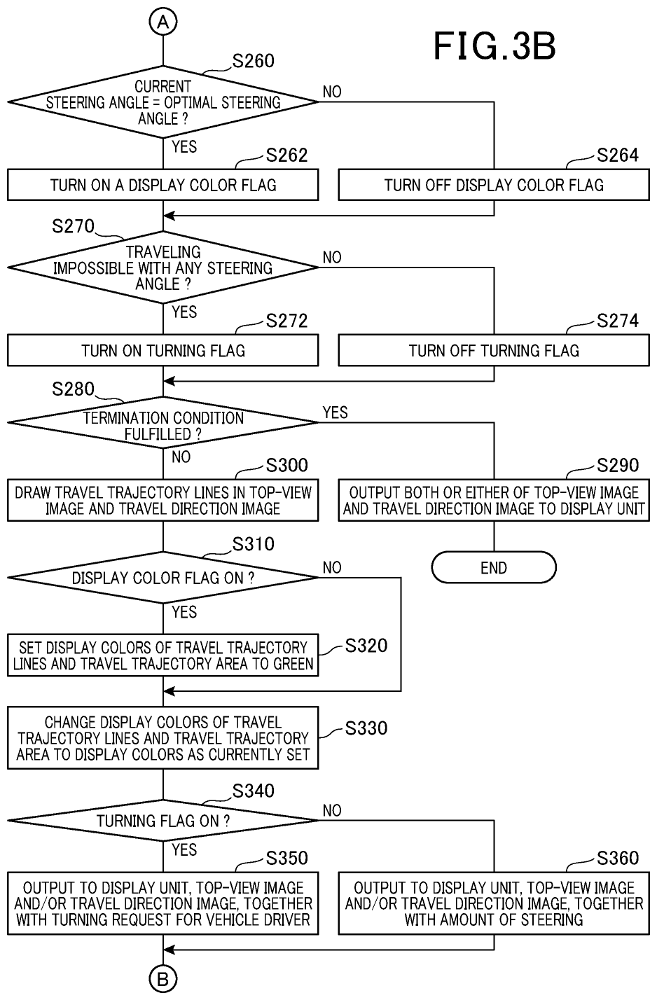

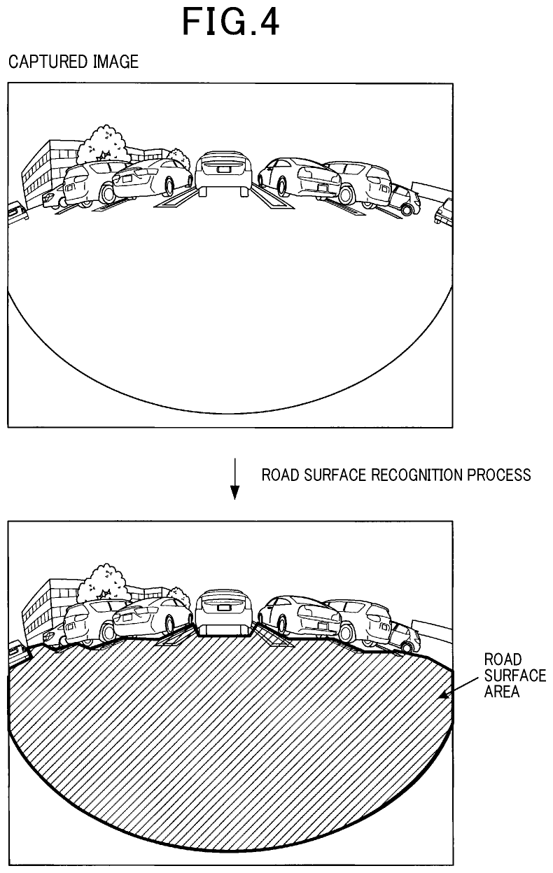

As shown in FIG. 1A, a surroundings monitoring apparatus 1 of the present embodiment is mounted to a vehicle 50 as shown in FIGS. 5 and 6. The surroundings monitoring apparatus 1 is configured to generate display images from images of surroundings of the vehicle 50 captured by a peripheral camera 10 and cause a display unit 48 to display the display images.

The surroundings monitoring apparatus 1 is configured as an electronic control unit (ECU) 30 for image processing.

The peripheral camera 10 includes a front view camera 11, a left side view camera 12, a right side view camera 13, and a rear view camera 14 to respectively capture front view images, left and right side view images, and rear view images.

Each of the cameras 11-14 may include a charge-coupled device (CCD) image sensor, a complementary metal-oxide semiconductor (CMOS) image sensor or the like. The number of cameras forming the peripheral camera 10 needs to be set appropriately such that these cameras can capture images of surrounding road surfaces and obstacles around the vehicle 50.

The display unit 48 is configured as a display of a navigation unit mounted to the vehicle 50 or a head-up display for displaying images on a front windshield of the vehicle 50.

The ECU 30 includes an image processor 40 configured to generate display images to be displayed on the display unit 48, an input signal processor 32 configured to input captured images from the cameras 11-14 to the image processor 40, and an output signal processor 34 configured to output the display images to the display unit 48.

The image processor 40 is configured as a microcomputer including a central processing unit (CPU), a read-only memory (ROM), a random-access memory (RAM), and an input/output interface (I/O). Functions of the image processor 40 are implemented by the CPU executing control programs stored in a non-volatile memory 36. The image processor 40 acquires the captured images from the input signal processor 32, performs image processing based on internal parameters stored in the memory 36 to generate display images, and outputs the generated display images to the output signal processor 34, thereby causing the display unit 48 to display the display images.

The image processor 40 receives detection signals from a state detector 20 configured to detect various states of the vehicle 50 via an input signal processor 38. The state detector 20 includes various sensors, such as a gearshift sensor 21 to detect a gearshift position of the transmission, a vehicle speed sensor 22 to detect a travel speed of the vehicle, a steering angle sensor 23 to detect a steering angle, and an illuminance sensor 24 to detect ambient brightness.

When generating display images to be displayed on the display unit 48, the image processor 40 determines a driving state and a surrounding environment of the vehicle 50 based on detection signals from various sensors forming the state detector 20, and generates display images appropriate to be presented to an occupant of the vehicle 50.

The ECU 30 further includes a power supply circuit 42 that is supplied with electric power from a battery mounted to the vehicle 50 and generates power supply voltages (i.e., constant DC voltages) to operate various components including the image processor 40.

Input and monitoring processes as main routines, performed by the image processor 40, will now be described.

Input Process

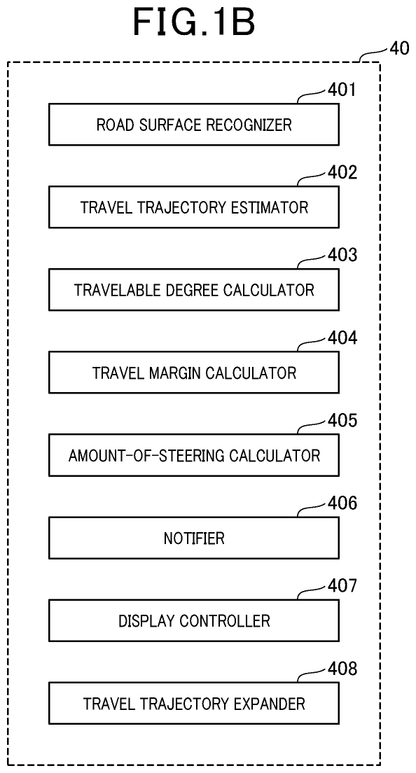

In the input process as shown in FIG. 2, at step S110, the image processor 40 acquires a variety of information, such as a gearshift position, a travel speed of the vehicle, a steering angle, an illuminance, from various sensors 21-24 forming the state detector 20 via the input signal processor 38.

At step S120, the image processor 40 acquires a front view image, a left side view image, a right side view image, and a rear view image from the cameras 11-14 forming the peripheral camera 10 via the input signal processor 32.

At step S130, the image processor 40 performs, using Semantic Segmentation or the like, a road surface recognition process to recognize a road surface on which the vehicle 50 can travel from captured images acquired from the cameras 11-14 at step S120. The road surface recognized at step S130 is hereinafter referred to as a travel surface.

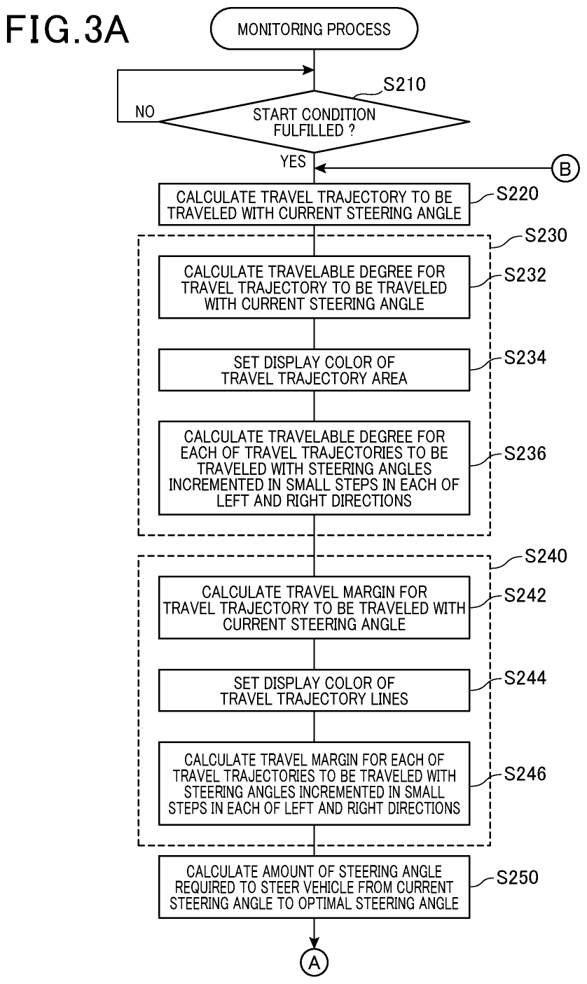

The image processor 40 performs the road surface recognition process, thereby serving as a road surface recognizer. In the road surface recognition process, as shown in FIG. 4, a road surface area shown hatched is recognized from captured images acquired from the cameras 11-14.

Semantic Segmentation refers to a process of linking each pixel in an image to an object class label using machine learning data and the like. Semantic Segmentation is described in detail in, for example, Japanese Patent No. 6309663 and thus description of a procedure to recognize road surfaces using Semantic Segmentation will be omitted.

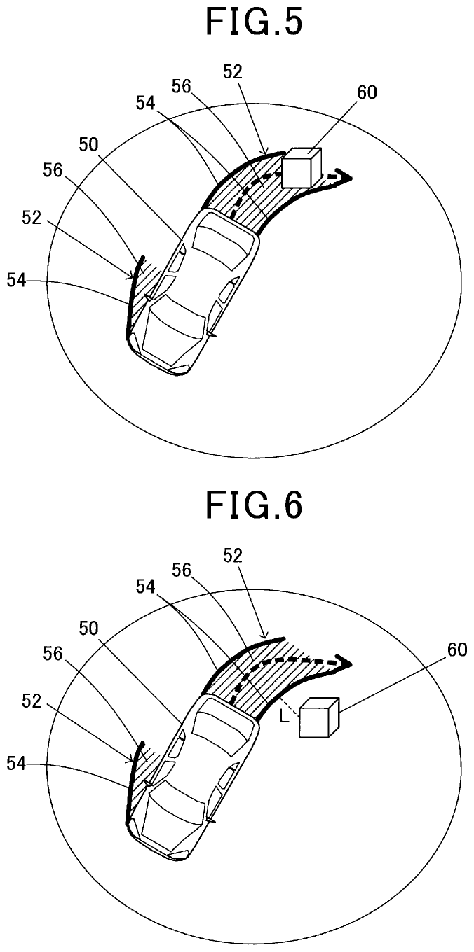

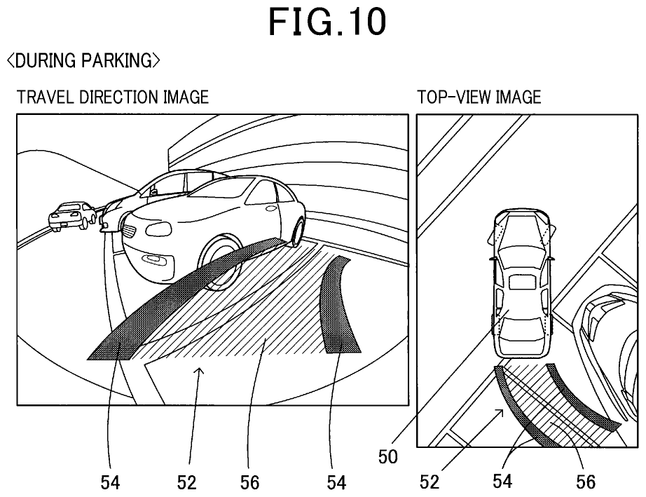

After the road surface recognition process is performed at step S130, the process flow proceeds to step S140. At step S140, the captured images from the cameras 11-14 are combined into a top view image of the vehicle 50. That is, at step S140, as shown in FIGS. 7 and 10, a top view image of surroundings of the vehicle 50 is generated.

After the top view image is generated at step S140, the process flow ends. This input process of FIG. 2 is repeatedly performed every predetermined time period. Each time the input process is performed, information from the respective sensors 21-24 and captured images from the respective cameras 11-14 are acquired. A road surface on which the vehicle 50 can travel is recognized for each captured image, and then a top view image generated by combining the captured images is generated.

Monitoring Process

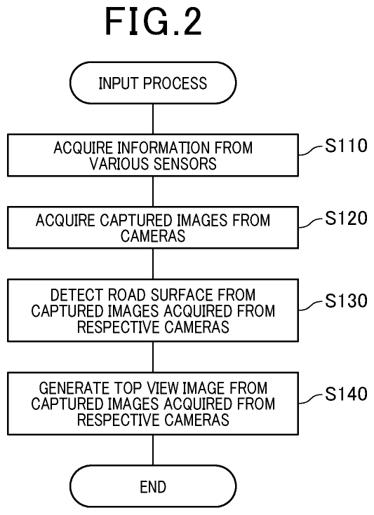

In the monitoring process as shown in FIGS. 3A, 3B, the image processor 40 estimates a travel trajectory based on a steering angle when the vehicle 50 is made to pull away from being parked or when the vehicle 50 is parked, and displays a guide image to avoid a collision of the vehicle 50 with an obstacle.

Referring to FIG. 3A, once the monitoring process is initiated, at step S210, the image processor 40 determines whether or not a start condition for the monitoring process is fulfilled. For example, in the present embodiment, the start condition includes conditions A1-A3 defined as follows.

The condition A1 is that a minimum distance between the vehicle 50 and an edge of a travel surface recognized at engine startup is equal to or less than a predetermined threshold, that is, a distance between the vehicle 50 and an edge of a travel surface has decreased due to the presence of an obstacle around the vehicle 50.

The condition A2 is that the gearshift of the transmission after engine startup has been placed in a “reverse” position that causes the vehicle 50 to travel in a reverse direction.

The condition A3 is that a start command has been input by a user of the vehicle 50 pressing a start button.

If at least one of the conditions A1-A3 is met, then at step S210 it is determined that the start condition is fulfilled. Then, the process flow proceeds to step S220. If none of the conditions A1-A3 are met where it is determined that the start condition is not fulfilled, the image processor 40 reperforms the decision step S210 to wait for the start condition to be fulfilled.

The condition A1 is a condition assuming a situation where the vehicle 50 pulls away from a parking lot, the condition A2 is a condition assuming a situation where the vehicle 50 is parked, and the condition A3 is a condition taking into account a driver's convenience. These start conditions A1-A3 are merely exemplary and may be appropriately modified to include additional conditions.

At step S220, based on the steering angle of the steering and the gearshift position of the transmission acquired at step S110, the image processor 40 calculates a travel trajectory 52 of the vehicle 50 when the vehicle 50 is driven with the gearshift kept in the current position, as shown in FIGS. 5 and 6. At step S220, the image processor 40 serves as a travel trajectory estimator.

At step S220, the gearshift position is used to determine whether a travel direction of the vehicle 50 is forward or backward. The travel trajectory 52 is a road surface area that the vehicle 50 will pass through when the vehicle 50 is driven with the current steering angle in the travel direction determined at step S220. Left and right boundaries of the road surface area are calculated as travel trajectory lines 54.

After the travel trajectory 52 of the vehicle 50 is estimated at step S220, the process flow proceeds to steps S230 and S240, where a travelable degree calculation process and a travel margin calculation process are performed. The travelable degree calculation process and the travel margin calculation process may be performed serially or in parallel.

In the travelable degree calculation process performed at step S230, at step S232, the image processor 40 calculates, based on the travel trajectory 52 estimated at step S220 and the travel surface recognized at step S130, a travelable degree indicating to what degree the vehicle 50 can travel the travel trajectory 52.

More specifically, as shown in FIG. 5, the image processor 40 determines whether or not there is a non-travelable area 60, other than the travel surface recognized at step S130, within the travel trajectory area 56 defined between the left and right travel trajectory lines 54 extending from the vehicle 50.

If there is a non-travelable area 60 within the travel trajectory area 56, the image processor 40 calculates a distance between the vehicle 50 and the non-travelable area 60. The image processor 40 sets the travelable degree such that the travelable degree decreases with decreasing distance between the vehicle 50 and the non-travelable area 60.

After the travelable degree is calculated at step S232, the image processor 40, at step S234, determines which one of “high”, “middle”, and “low” ranges the travelable degree calculated at step S232 belongs to, and based on a result of determination at step S232, set a display color of the travel trajectory area 56.

If the distance between the vehicle 50 and the non-travelable area 60 is equal to or less than a first threshold (e.g., 1 m) and the travelable degree thus belongs to the “low” range, the vehicle 50 is likely to collide with an obstacle recognized as the non-travelable area 60. In such a case, the display color of the travel trajectory area 56 is set to red.

If the distance between the vehicle 50 and the non-travelable area 60 is greater than the first threshold and equal to or less than a second threshold (e.g., 3 m) and the travelable degree thus belongs to the “middle” range, the vehicle 50 is less likely to collide with an obstacle recognized as the non-travelable area 60. In such a case, the display color of the travel trajectory area 56 is set to yellow.

If the distance between the vehicle 50 and the non-travelable area 60 is greater than the second threshold and the travelable degree thus belongs to the “high” range, the vehicle 50 will not collide with an obstacle recognized as the non-travelable area 60. In such a case, the display color of the travel trajectory area 56 is set to green (or blue).

As above, in the present embodiment, the display color of the travel trajectory area 56 is set in three steps—red, yellow, and green, in response to the travelable degree when the vehicle 50 is driven with the current steering angle.

The travel trajectory 52 is displayed on the display unit 48 such that the travel trajectory area 56 depicted in the display color set in the above manner is overlaid on the captured image in the forward direction of travel of the vehicle 50 (hereinafter referred to as a travel direction image) or the top-view image, which enables notification of the travelable degree to the driver of the vehicle 50.

Subsequently, at step S236, the image processor 40 estimates a travel trajectory when the vehicle 50 is driven with a respective one of steering angles incremented in small steps of a constant value from the current steering angle to a maximum steering angle in each of the left and right directions, and calculates a travelable degree for each of the estimated travel trajectories in a similar manner as in step S232. Step S236 is performed to acquire an optimal steering angle for driving the vehicle 50 in the subsequent processes.

In the travel margin calculation process at step S240, at step S242, the image processor 40 calculates, based on the travel trajectory 52 estimated at step S220 and the travel surface recognized at step S130, a travel margin when the vehicle 50 travels the travel trajectory 52.

More specifically, as shown in FIG. 6, the image processor 40 selects, from non-travelable areas 60 located outside the travel trajectory 52 of the vehicle 50, a non-travelable areas 60 that is closest to the travel trajectory lines 54, and calculates a distance L between the selected non-travelable area 60 and the travel trajectory line 54.

The distance L can be calculated by drawing a line perpendicular to a tangent line to a closer one of the travel trajectory lines 54 to the selected non-travelable area 60 between the closer one of the travel trajectory lines 54 and the selected non-travelable area 60, as indicated by a dotted line in FIG. 6. The travel margin is set to be decreased as the distance L decreases.

After the travel margin is calculated at step S242, at step S244, the image processor 40 determines which one of three ranges—“high”, “middle”, and “low” ranges, the travel margin calculated at step S242 belongs to, and sets a display color of the travel trajectory lines 54.

If the distance L between the closer one of the travel trajectory lines 54 and the selected non-travelable area 60 is equal to or less than a first threshold (e.g., 0.5 m) and the travel margin belongs to the “low” range, the display color of the travel trajectory lines 54 is set to red.

If the distance L between the closer one of the travel trajectory lines 54 and the selected non-travelable area 60 is greater than the first threshold and equal to or less than a second threshold (e.g., 2 m) and the travel margin belongs to the “middle” range, the display color of the travel trajectory line 54 is set to yellow.

If the distance L between the closer one of the travel trajectory lines 54 and the selected non-travelable area 60 is greater than the second threshold and the travel margin belongs to the “high” range, the display color of the travel trajectory line 54 is set to green.

As above, in the present embodiment, the display color of the travel trajectory line 54 is set in three steps—red, yellow, and green, in response to the travel margin when the vehicle 50 is driven with the current steering angle.

The travel trajectory 52 is displayed on the first image display unit 48 such that the travel trajectory lines 54 in the display color set as above is overlaid on the travel direction image or the top-view image, which enables notification of the travel margin to the driver.

Subsequently, at step S246, the image processor 40 estimates a travel trajectory when the vehicle 50 is driven with a respective one of steering angles incremented in small steps of a constant value from the current steering angle to a maximum steering angle in each of the left and right directions, and calculates a travel margin for each of the estimated travel trajectories in a similar manner as in step S242.

After the travelable degree calculation process at step S230 and the travel margin calculation process at step S240 are performed, the process flow proceeds to step S250. At step S250, the image processor 40 estimates an optimal steering angle to drive the vehicle 50 based on the plurality of travelable degrees calculated at step S230 and the plurality of travel margins calculated at step S240.

That is, at steps S230 and S240, in addition to the travelable degree and the travel margin for the travel trajectory to be traveled with the current steering angle, a plurality of travelable degrees and a plurality of travel margins are calculated for the travel trajectories to be traveled with the plurality of steering angles incremented in small steps between a maximum steering angle and the current steering angel in each of the left and right directions. The maximum steering angles in the left and right directions define a steerable range of the vehicle 50.

Thus, at step S250, one or more steering angles that lead to a highest travelable degree are extracted from a plurality of steering angles including the current steering angle, used to calculate the travelable degrees and the travel margins at steps S230 and S240.

Further, at step S250, an optimal steering angle is set by extracting from the one or more extracted steering angles, a steering angle that leads to a largest travel margin. If there are a plurality of steering angles selectable as an optimal steering angle, the current steering angle or a steering angle closest to the current steering angle is selected from the plurality of steering angles selectable as an optimal steering angle.

Still further, at step S250, an amount of steering required to steer the vehicle 50 from the current steering angel to the optimal steering angle is calculated. The process flow proceeds to step S260 shown in FIG. 3B.

At step S260, the image processor 40 determines whether or not the current steering angle is equal to the optimal steering angle. If the current steering angle is equal to the optimal steering angle, then at step S262 the image processor 40 turns on a display color flag. The process flow then proceeds to step S270. If the current steering angle is not equal to the optimal steering angle, then at step S264 the image processor 40 turns off the display color flag. The process flow then proceeds to step S270.

When the display color flag is on, the display color of the travel trajectory lines 54 and the travel trajectory area 56 are set to green, regardless of the display color set at steps S230 and S240.

That is, even if the travelable degree calculated at S232 or the travel margin calculated at step S242 belongs to the “middle” or “low “range, the display color of the travel trajectory lines 54 or the travel trajectory area 56 will be set to green if the current steering angle is equal to the optimal steering angle.

Therefore, in cases where the current steering angle is equal to the optimal steering angle, this configuration can prevent the driver of the vehicle 50 from deciding that the vehicle 50 can not start or park in a situation where the display color of the travel trajectory lines 54 or the travel trajectory area 56 is yellow or red.

At step S270, the image processor 40 determines whether or not traveling of the vehicle 50 is impossible with any one of the plurality of steering angles (including the current steering angle) that were used to calculate the travelable degree and the travel margin at steps S230 and S240.

That is, at step S270, based on the travelable degree and the travel margin calculated for each of the plurality of steering angles, the image processor 40 determines whether or not there is a travel trajectory that the vehicle 50 can travel in safety. If there is no travel trajectory that the vehicle 50 can travel in safety, then the image processor 40 determines that traveling of the vehicle 50 is impossible.

If, at step S270, it is determined that traveling of the vehicle 50 is impossible with any one of the plurality of steering angles, then the process flow proceeds to step S272. At step S272, the image processor 40 turns on a turning flag to cause the driver of the vehicle 50 to perform a turning maneuver. The process flow then proceeds to step S280. If, at step S270, it is determined that traveling of the vehicle 50 is allowed, then the process flow proceeds to step S274. At step S274, the image processor 40 turns off the turning flag. The process flow then proceeds to step S280.

At step S280, the image processor 40 determines whether or not a termination condition for the monitoring process is fulfilled. For example, in the present embodiment, the termination condition includes conditions B1-B3 defined as follows.

The condition B1 is that the travel speed of the vehicle 50 has reached or exceeded a threshold.

The condition B2 is that a minimum distance between the vehicle 50 and an edge of a travel surface is equal to or greater than a predetermined threshold.

The condition B3 is that the gearshift of the transmission has been placed in a parking position.

The condition B4 is that the user has pressed a termination button to input a termination command.

The conditions B1, B2 are conditions assuming a situation where there are no obstacles in the forward direction of travel of the vehicle 50 after the vehicle 50 has started. The condition B3 is a condition assuming a situation where parking of the vehicle 50 is completed. The condition B4 is a condition taking into account a driver's convenience. The termination conditions B1-B4 are example conditions and may be modified, for example, by adding another condition thereto.

If at least one of the conditions B1-B4 is met, then at step S280 the image processor 40 determines that the termination condition is fulfilled. Then, the process flow proceeds to step S290. At step S290, the image processor 40 outputs a top-view image and a travel direction image to the display unit 48 via the output signal processor 34. Thereafter, the process flow ends.

As a result, both or driver-preset one of the top-view image and the travel direction image are displayed on the display unit 48.

The process flow ends after completion of step S290. The monitoring process will be restarted with the determination process of step S210 after expiry of a predetermined period of time therefrom. Thereafter, the top-view image and the travel direction image to be output to the display unit 48 will be updated to the last ones generated or acquired in the input process until it is determined at step S210 that it is determined that the start condition is fulfilled.

If, at step S280, it is determined that the termination condition is not fulfilled, then at step S300 the image processor 40 draws travel trajectory lines in the last top-view image generated at step S140 and the last travel direction image acquired at step S120. Thereafter, the process flow proceeds to step S310.

At step S310, the image processor 40 determines whether or not the display color flag is on. If the display color flag is on, then at step S320 the image processor 40 sets the display colors of the travel trajectory lines 54 and the travel trajectory area 56 to green, which indicates that the travel margin and the travelable degree belong to the “high” range. The process flow then proceeds to step S330. If the display color flag is off, the process flow directly proceeds to step S330.

At step S330, as shown in FIGS. 7 and 10, the image processor 40 changes, in the top-view image and the travel direction image having the travel trajectory lines 54 drawn at step S300, the colors of the travel trajectory lines 54 and the travel trajectory area 56 between the travel trajectory lines 54 to the respective display colors as currently set.

FIG. 7 illustrates a top-view image and a travel direction image during pulling away of the vehicle 50 from being parked. FIG. 10 illustrates a top-view image and a travel direction image during backward parking of the vehicle 50.

For example, in cases where there is no non-travelable area as an obstacle within the travel trajectory area 56 and the travelable degree of the travel trajectory 52 belongs to the “high” range or in cases where the display color flag is on, the travel trajectory area 56 will be displayed in green, as shown in FIG. 7.

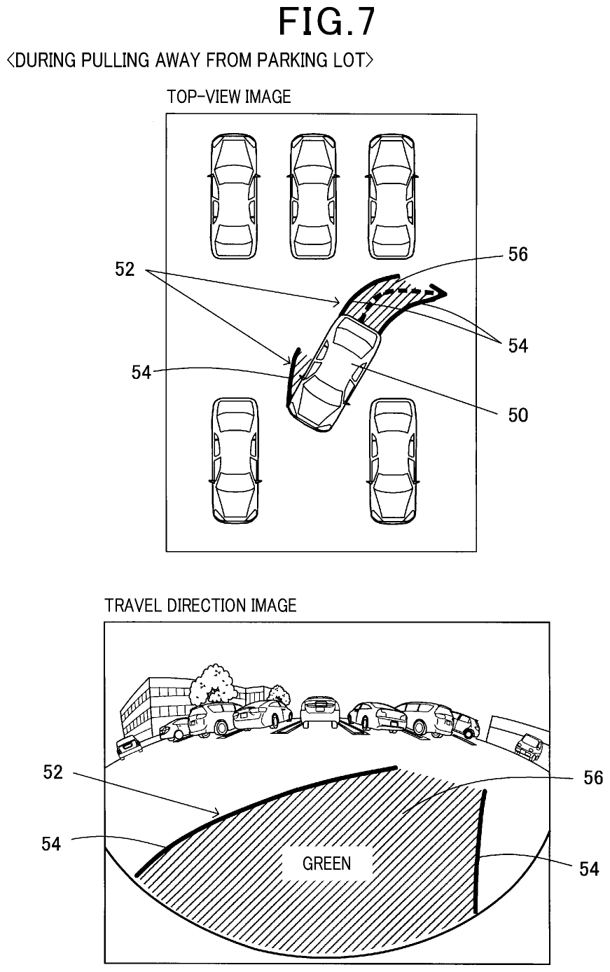

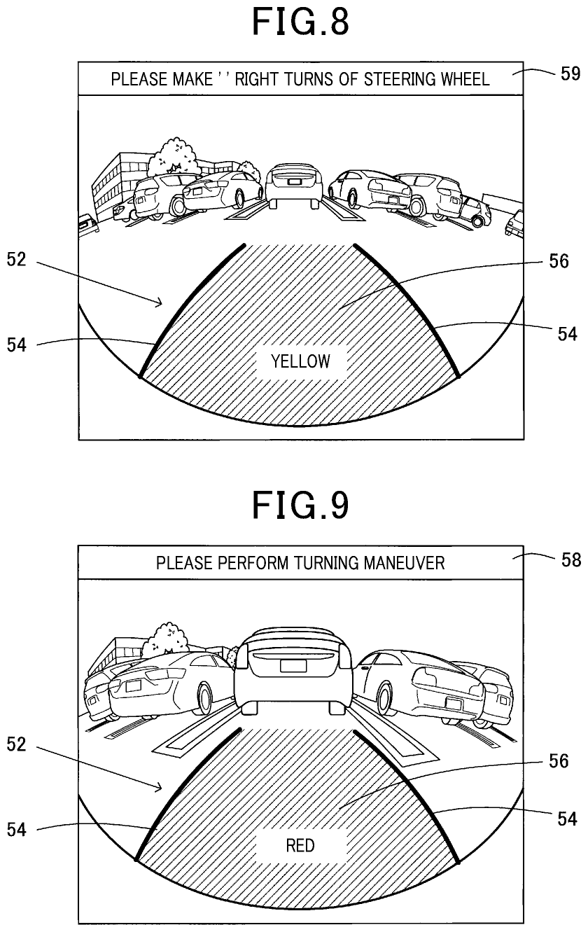

For example, during pulling away of the vehicle 50 from a parking lot, the vehicle 50 approaching another vehicle in the forward direction of travel will lead to the travelable degree belonging to the “middle” or “low” range. In such a case, the travel trajectory area 56 will be displayed in yellow or red in response to the travelable degree, as shown in FIG. 8 or 9.

Like the travel trajectory area 56, the travel trajectory lines 54 in the top-view image and the travel direction image will be changed in the display color in response to the travel margin.

After the top-view image and the travel direction image having the travel trajectory 52 overlaid in the display color as currently set are generated at step S330, the process flow proceeds to step S340. At step S340, the image processor 40 determines whether or not the turning flag is on.

If, at step S340, it is determined that the turning flag is on, then the process flow proceeds to step S350. At step S350, the image processor 40 outputs to the display unit 48, the top-view image and the travel direction image having the travel trajectory 52 overlaid at step S330 and a turning request for the driver.

As a result, as shown in FIG. 9, both or either of the top-view image and the travel direction image having the travel trajectory 52 overlaid in the display color as currently set, together with a message 58 requesting the driver to perform a turning maneuver, are displayed on the display unit 48.

This configuration allows the driver to recognize, from the display image(s) on the display unit 48, that a turning maneuver needs to be performed to safely start or park the vehicle 50, which enables safe starting or parking of the vehicle 50.

Requesting the driver to perform the turning maneuver at step S350 may be implemented by both or either of displaying a message 58 and outputting an audible sound.

If, at step S340, it is determined that the turning flag is off, the process flow proceeds to step S360. At step S360, the image processor 40 outputs the top-view image and the travel direction image having the travel trajectory 52 overlaid at step S330 and an amount of steering from the current steering angle to the display unit 48.

As a result, as shown in FIG. 8, both or either of the top-view image and the travel direction image having the travel trajectory 52 overlaid in the display color as currently set, together with a message 59 indicating an amount of steering are displayed on the display unit 48.

This configuration allows the driver to know, from the display image(s) on the display unit 48, a more optimal amount of steering for starting or parking the vehicle 50, which enables safer starting or parking of the vehicle 50.

The message 59 indicating the amount of steering may be displayed as a figure or a text, such as ½ turn, 1 turn of the steering wheel or the like. Alternatively, only a rotational direction of the steering wheel, indicated by an arrow, may be displayed as the message 59. The amount of steering may be notified using both the message 59 and an audible sound, or using an audible sound only.

After completion of step S350 or S360 where the top-view image and the travel direction image with the travel trajectory 52 overlaid are output, the process flow returns to step S220. Thereafter, steps S220 to S360 will be repeated until it is determined that the termination condition is fulfilled.

Advantages

As described above, the image processor 40 performs the monitoring process to estimate a travel trajectory from the current location of the vehicle 50 and calculates a travelable degree and a travel margin based on the estimated travel trajectory and a result of recognition of a travel surface in the input process.

The calculated travelable degree and the calculated travel margin are used to set the display colors of the travel trajectory area 56 and the travel trajectory lines 54 of the travel trajectory 52 to be overlaid on the top-view image and the travel direction image shown on the display unit 48.

This configuration allows the driver to know from the colors of the travel trajectory area 56 and the travel trajectory lines 54 of the travel trajectory 52 shown on the display unit 48, the travelable degree and the travel margin when the vehicle 50 is driven with the current steering angle.

For example, if the travelable degree and the travel margin are low such that the display colors of the travel trajectory area 56 and the travel trajectory lines 54 are red, the driver can recognize that the vehicle 50 is likely to collide with an obstacle if the current driving of the vehicle 50 is continued, which allows the driver to take a steering action for collision avoidance.

A result of road surface recognition based on images captured by cameras 11-14 is utilized to calculate the travelable degree and the travel margin. In addition, imageable ranges of the camera 11-14 are greater than an obstacle sensing distance of an ultrasonic sensor. Therefore, a non-travelable area as an obstacle that hinders a travel trajectory will be recognized farther away from the obstacle, as compared with conventional devices.

This configuration allows the driver at a location further away from the obstacle to recognize that the travelable degree or the travel margin is low and thus take a steering action for collision avoidance in good time. The surroundings monitoring apparatus of the present embodiment can enhance driving safety during traveling of the vehicle 50, particularly, during starting or parking of the vehicle 50, as compared with conventional devices.

In the present embodiment, as shown in FIG. 1B, the image processor 40 includes, as functional blocks, a road surface recognizer 401, a travel trajectory estimator 402, a travelable degree calculator 403, a travel margin calculator 404, an amount-of-steering calculator 405, a notifier 406, a display controller 407, and a travel trajectory expander 408. Functions of these blocks may be implemented by software, that is, by the CPU executing computer programs stored in the non-volatile memory 36.

More specifically, in the input process performed by the image processor 40, the road surface recognizer 401 is responsible for execution of step S130. In the monitoring process, the travel trajectory estimator 402 is responsible for execution of step S220, the travelable degree calculator 403 is responsible for execution of step S230, and the travel margin calculator 404 is responsible for execution of step S240.

The amount-of-steering calculator 405 is responsible for execution of step S250. The notifier 406 is responsible for execution of steps S260 to S340. The display controller 407 is responsible for execution of steps S350 and S360. The travel trajectory expander 408 is responsible for execution of steps S236 and S246.

Modifications

The embodiments of the present disclosure have been described, but the present disclosure is not limited to the above embodiments and may be modified in various manners.

In the above embodiment, the travelable degree of the estimated travel trajectory 52 for the vehicle 50 is calculated based on a distance between the vehicle 50 and a non-travelable area 60 within the travel trajectory area 56.

In an alternative embodiment, the travelable degree may be calculated based on a travel time taken for the vehicle 50 to travel to the non-travelable area 60 within the travel trajectory area 56, such that the travelable degree is lowered with decreasing travel time.

In the above embodiment, the travelable degree and the travel margin calculated based on a positional relationship between the travel trajectory and the non-travelable area are set in three steps—“high”, “middle”, and “low”. The colors of the travel trajectory area 56 and the travel trajectory lines 54 are set in three steps—red, yellow, and green.

In alternative embodiments, the travelable degree and the travel margin may be notified by changing the display color not in such a stepwise manner, but in a continuous manner. In addition, the travel trajectory area 56 and the travel trajectory lines 54 may be displayed in colors other than “green”, “yellow”, and “red”, or may be in gradations of color.

In alternative embodiments, the travelable degree may be notified not via colors of the travel trajectory 52 displayed on the display unit 48, but via audible sounds or via both. The color of the travel trajectory lines 54 may be changed per unit distance from the vehicle 50 in a travel direction of the vehicle 50.

As described above, in the above embodiment, the functions of the road surface recognizer 401, the travel trajectory estimator 402, the travelable degree calculator 403, the travel margin calculator 404, the amount-of-steering calculator 405, the notifier 406, the display controller 407, and the travel trajectory expander 408 of the image processor 40 may be implemented by the CPU executing the control programs.

These functions of the image processor 40 may not be limited to implementation by software only. These functions of the image processor 40 may be implemented by hardware only or a combination of software and hardware. For example, when these functions are provided by an electronic circuit which is hardware, the electronic circuit can be provided by a digital circuit including many logic circuits, an analog circuit, or a combination thereof.

A plurality of functions possessed by one constituent element in the foregoing embodiments may be implemented by a plurality of constituent elements, or one function possessed by one constituent element may be implemented by a plurality of constituent elements. In addition, a plurality of functions possessed by a plurality of constituent elements may be implemented by one constituent element, or one function implemented by a plurality of constituent elements may be implemented by one constituent element. Some of the components in the foregoing embodiments may be omitted. At least some of the components in the foregoing embodiments may be added to or replaced with the other embodiments.

Besides the surroundings monitoring apparatus disclosed above, the present disclosure may be embodied in various forms, e.g., as a computer program enabling a computer to function as the surroundings monitoring apparatus, a tangible, non-transitory computer-readable medium, such as a semiconductor memory, bearing this computer program, and a surroundings monitoring method performed in the surroundings monitoring apparatus.

What is claimed is:

1. An apparatus for monitoring surroundings of a vehicle, comprising:
a road surface recognizer configured to recognize from an image of surroundings of the vehicle captured by a camera, a road surface on which the vehicle can travel;
a travel trajectory estimator configured to estimate a travel trajectory from a current location of the vehicle based on a steering state of the vehicle;
a travelable degree calculator configured to, based on the travel trajectory estimated by the travel trajectory estimator and a result of recognition of the road surface by the road surface recognizer, calculate a travelable degree that is a degree to which the vehicle can travel on the road surface; and
a notifier configured to provide a notification of the travelable degree calculated by the travelable degree calculator.

2. The apparatus according to claim 1, wherein the notifier is configured to provide a stepwise notification of the travelable degree.

3. The apparatus according to claim 2, further comprising a display controller configured to, based on the captured image from the camera, display on a display unit the image of surroundings of the vehicle with the travel trajectory overlaid,
wherein the notifier is configured to provide the stepwise notification of the travelable degree by changing a display form in which the display controller displays on the display unit the travel trajectory overlaid on the image of surroundings of the vehicle in response to the travelable degree.

4. The apparatus according to claim 3, further comprising a travel margin calculator configured to, based on the travel trajectory estimated by the travel trajectory estimator and the result of recognition of the road surface by the road surface recognizer, calculate a travel margin with which to travel the travel trajectory for a non-travelable area located outside the travel trajectory,
wherein the notifier is configured to cause the display controller to display on the display unit travel trajectory lines that are boundaries of the travel trajectory in a display form responsive to the travel margin calculated by the travel margin calculator.

5. The apparatus according to claim 4, further comprising:
a travel trajectory expander configured to vary the travel trajectory within a steerable range of the vehicle and calculate the travelable degree and the travel margin for each of a plurality of varying travel trajectories; and
an amount-of-steering calculator configured to select from the travel trajectory estimated by the travel trajectory estimator based on the steering state and the plurality of varying travel trajectories acquired by the travel trajectory expander varying the travel trajectory within the steerable range of the vehicle, a travel trajectory having a maximum travelable degree and a large travel margin, and calculate an amount of steering required to drive the vehicle with the selected travel trajectory,
wherein the notifier is configured to provide a notification of the amount of steering calculated by the amount-of-steering calculator.

6. The apparatus according to claim 5, wherein the notifier is configured to, if the vehicle can not travel any one of the travel trajectory estimated by the travel trajectory estimator based on the steering state and the plurality of varying travel trajectories acquired by the travel trajectory expander varying the travel trajectory within the steerable range of the vehicle, request a turning maneuver of the vehicle.

7. The apparatus according to claim 1, wherein the travelable degree calculator is configured to, if there is a non-travelable area that is not recognized by the road surface recognizer as a road surface within an area of the travel trajectory estimated by the travel trajectory estimator, calculate the travelable degree such that the travelable degree is lowered as a distance from the vehicle to the non-travelable area decreases.

8. The apparatus according to claim 1, wherein the travelable degree calculator is configured to, if there is a non-travelable area that is not recognized by the road surface recognizer as a road surface within an area of the travel trajectory estimated by the travel trajectory estimator, calculate the travelable degree such that the travelable degree is lowered as a time taken for the vehicle to travel to the non-travelable area decreases.

9. The apparatus according to claim 4, wherein the travel margin calculator is configured to calculate the travel margin such that the travel margin decreases as a distance between the travel trajectory estimated by the travel trajectory estimator and a non-travelable area closest to the travel trajectory estimated by the travel trajectory estimator decreases.

10. A method for monitoring surroundings of a vehicle, comprising:
recognizing from an image of surroundings of the vehicle captured by a camera, a road surface on which the vehicle can travel;
estimating a travel trajectory from a current location of the vehicle based on a steering state of the vehicle;
calculating, based on the estimated travel trajectory and a result of recognition of the road surface, a travelable degree that is a degree to which the vehicle can travel on the road surface; and
providing a notification of the calculated travelable degree.
